(19) United States
(12) Patent Application Publication
(10) Pub. No.: US 2015/0344729 A1
(43) Pub. Date: Dec. 3, 2015

(54) HEAT SEAL COATING FOR USE ON SUBSTRATES

(71) Applicant: Michelman, Inc., Cincinnati, OH (US)

(72) Inventors: D. Ryan Breese, Loveland, OH (US); Robin Cooper, Attert (BE); Krist Vanderstiggel, Veerle Laakdal (BE); Edward R. Gay, Cincinnati, OH (US); Richard Michelman, Cincinnati, OH (US)

(73) Assignee: MICHELMAN, INC., Cincinnati, OH (US)

(21) Appl. No.: 14/722,465

(22) Filed: May 27, 2015

Related U.S. Application Data
(60) Provisional application No. 62/004,956, filed on May 30, 2014.

(51) Int. Cl. C09D 177/00; B32B 37/12; C09D 175/04

(52) U.S. Cl. CPC C09D 177/00; C09D 175/04; B32B 37/1207; B32B 2037/1215; B32B 2377/00

(57) ABSTRACT

Heat seal coatings including an aqueous dispersion having a mixture of a polyamide and a copolymer of ethylene and acrylic acid are provided for use on a variety of substrates. In various embodiments, the aqueous dispersion is substantially free of non-aqueous plasticizers and organic solvents. Also provided is a method of heat sealing substrates, the method including applying an aqueous dispersion to a first substrate, drying the aqueous dispersion on the first substrate to form a coating on the first substrate, and heat sealing the first substrate to a second substrate at a temperature ranging from about 75° C. to about 140° C. The disclosure also describes a substrate coated with a heat sealed layer including a mixture of polyamide and a copolymer of ethylene and acrylic acid.

### CROSS-REFERENCE TO RELATED APPLICATIONS

This application claims the benefit of U.S. Patent Application Ser. No. 62/004,956, filed May 30, 2014, which is hereby incorporated by reference in its entirety.

### TECHNICAL FIELD

Embodiments described herein relate generally to coatings for use on a variety of substrates, and more particularly, to heat seal coatings that include an aqueous dispersion of polyamide and a copolymer of ethylene and acrylic acid.

### BACKGROUND

Coatings including copolymers of ethylene and acrylic acid have been employed to provide heat seal properties to polymeric films or other substrates used in packaging applications. For example, polymeric films such as biaxially oriented polypropylene are often used in packaging candy bars and other foods. The application of heat and pressure to the substrate seals the film to itself or to another substrate. As such substrates generally exhibit poor heat sealing characteristics, a heat sealable coating is typically applied to the substrate which allows the substrate to be sealed over a relatively wide temperature range and which adheres securely to the substrate surface. Examples of heat sealable coatings are described in U.S. Pat. No. 5,419,960 and U.S. Pat. No. 6,447,899.

However, heat seal coatings which are currently in use typically require sealing temperatures of at least about 90° C. Further, such coatings often do not provide satisfactory hot tack properties to the substrate, i.e., the strength of the heat seal provided when the coating is heated to a temperature at or above the melting point of the polymer coating. In addition, many of the coatings currently require the use of a primer to aid in enhancing adhesion of the heat sealable coating to the film surface. Accordingly, there is a further need for a heat seal coating which provides a high heat seal strength at a low heat seal initiation temperature.

Accordingly, there is a need in the art for a coating which can be used to provide enhanced heat seal characteristics.

### SUMMARY

In various embodiments, a coating for providing heat sealability to a substrate includes an aqueous dispersion. The aqueous dispersion includes a mixture of a polyamide and a copolymer of ethylene and acrylic acid. The aqueous dispersion is substantially free of non-aqueous plasticizers and organic solvents.

In other embodiments, a substrate is coated with a heat seal layer. The heat seal layer includes an aqueous dispersion including a mixture of polyamide and a copolymer of ethylene and acrylic acid. The heat seal layer has a heat seal initiation temperature of between about 75° C. and about 140° C.

In still other embodiments, a method of heat sealing substrates includes applying an aqueous dispersion to a first substrate, drying the aqueous dispersion on the first substrate to form a coating on the first substrate, and heat sealing the first substrate to a second substrate at a temperature ranging from about 75° C. to about 140° C. The aqueous dispersion includes from about 10% to about 50% by weight solids and the balance water and ammonia. The solids include a mixture of polyamide and a copolymer of ethylene and acrylic acid.

Accordingly, various embodiments are directed to a heat seal coating for substrates which include an aqueous dispersion of a polyamide and ethylene acrylic acid copolymer. These and other features and advantages of various embodiments will become apparent from the following detailed description and the appended claims.

### DETAILED DESCRIPTION

Reference will now be made in detail to various embodiments of coatings that include an aqueous dispersion of polyamide which may be used to provide a heat seal. The components of the coating generally include a dispersion of a polyamide and a copolymer of ethylene and acrylic acid. Embodiments of the coatings described herein provide improved bond strength when used as heat seal coatings. For example, various embodiments may provide enhanced seal strength on substrates coated with the heat seal which are heat sealed at temperatures above about 75° C. Various embodiments of heat seal coatings, coated substrates, and methods of sealing substrates using the same will be described.

Unless otherwise indicated, the disclosure of any ranges in the specification and claims are to be understood as including the range itself and also anything subsumed therein, as well as endpoints. As used herein, the term “heat sealability” means that the substrate may be sealed to itself or to another substrate by the application of heat and pressure. In various embodiments, the heat seal coating provides heat sealability at temperatures ranging from about 75° C. to about 140° C.

In various embodiments, a heat seal coating includes an aqueous dispersion including a mixture of a polyamide and a copolymer of ethylene and acrylic acid. As used herein, a “dispersion” refers to a particulate discontinuous phase in a continuous liquid medium. An aqueous dispersion is a dispersion in which the continuous liquid medium is water.

In some embodiments, the dispersion mixture may further include polyurethane and/or one or more additives such as defoaming agents, such as Michelman DF016 (commercially available from Michelman, Inc., Cincinnati, Ohio), and wetting agents such as glycol. Various embodiments may also include ammonia or other neutralizers. The balance of the dispersion may be water. Various embodiments of the aqueous dispersion are substantially free of non-aqueous plasticizers and organic solvents. By “substantially free,” we mean that less than 1 wt % of non-aqueous plasticizers and organic solvents are present.

According to various embodiments, the aqueous dispersion contains from about 10% to about 50% by weight solids. In some embodiments, the aqueous dispersion contains from about 10% to about 30% by weight solids. In other embodiments, the aqueous dispersion contains from about 15% to about 30% by weight solids. The aqueous dispersion in various embodiments contains from about 50% to about 90% by weight water. In some embodiments, the aqueous dispersion contains from about 70% to about 90% by weight water. In still other embodiments, the aqueous dispersion contains from about 75% to about 85% by weight water.

In various embodiments, the polyamide is present in an amount from about 50% to about 75% by weight based on the solids. In some embodiments, the polyamide is present in an amount from about 50% to about 70% by weight based on the solids. In other embodiments, the polyamide is present in an amount from about 65% to about 75% by weight based on the solids. In still other embodiments, the polyamide is present in an amount from about 60% to about 70% by weight based on the solids. In formulations including greater than about 75% polyamide, the dispersion may not be stable and the polyamide may not remain suitably dispersed in the mixture. Additionally, such formulations may exhibit undesirable optical properties. In various embodiments, the polyamides are highly branched, low molecular weight aliphatic polyamides based on fatty acids such as oleic acid. Commercially available polyamides suitable for use may include, by way of example and not limitation, those sold under the trade names Macromelt® (available from Henkel) and Platamid® (available from Arkema). The polyamides included in the aqueous dispersion may be hot melt adhesives.

According to various embodiments, the polyamide is an amine-terminated polyamide. In some embodiments, polyamides with other terminal functional groups, such as an acid group, may be used in the dispersion. In such embodiments, the use of a functional-terminated polyamide in the dispersion may result in improved adhesion of the heat seal coating to the substrate, and therefore, a stronger seal, when compared to a dispersion including a “non-functional” polyamide. As used herein, a “non-functional” polyamide refers to a polyamide lacking a chemically reactive functional terminal group. Non-functional polyamides can include, for example, nylon 6,6 or nylon 12. In some embodiments, the use of a functional-terminated polyamide may further provide enhanced flexibility of the coating when compared to a coating including a non-functional polyamide.

As disclosed hereinabove, in some embodiments, the heat seal coating may optionally also include polyurethane. The polyurethane may be present in an amount of greater than 0% to about 60% by weight based on the solids. In some embodiments, the polyurethane is present in an amount of greater than 0% to about 40% by weight based on the solids. In still other embodiments, the polyurethane is present in an amount from about 10% to about 20% by weight based on the solids. Suitable polyurethanes for use include, by way of example and not limitation, Dispercoll® U53, U43, and U56, commercially available from Bayer, and NeoRez®, commercially available from DSM, which are in the form of an aqueous polyurethane dispersion.

In various embodiments, the ethylene acrylic acid copolymer is present in the dispersion in an amount from about 10% to about 40% by weight based on the solids. In some embodiments, the ethylene acrylic acid copolymer is present in an amount from about 20% to about 40% by weight based on the solids. In still other embodiments, the ethylene acrylic acid copolymer is present in an amount from about 25% to about 35% by weight based on the solids. Without being bound by theory, in formulations including greater than about 40% ethylene acrylic acid copolymer, the dispersion may not exhibit a suitable heat seal strength and/or may have a heat seal temperature greater than suitable for particular implementations. However, in formulations including less than about 10% ethylene acrylic acid copolymer, the dispersion may become unstable, and, in particular, the polyamide may not remain suitably dispersed because the ethylene acrylic acid is not present in an amount sufficient to effectively act as a surfactant for the polyamide.

Without being bound by theory, it is believed that the ethylene acrylic acid copolymer acts as a polymeric surfactant to maintain the polyamide in dispersion. Conventionally, polyamides are difficult to disperse in water. However, in the embodiments described herein, the combination of ethylene acrylic acid copolymer with polyamide enables a stable water-based dispersion.

The copolymer may have a number average molecular weight of about 2,000 to about 180,000. In various embodiments, the copolymer includes from about 65% to about 80% by weight ethylene comonomers and from about 10% to about 35% acrylic acid comonomers. However, in some embodiments, the copolymer includes from about 10% to about 30% acrylic acid comonomers. In still other embodiments, the copolymer includes from about 15% to about 20% acrylic acid comonomers.

According to some embodiments, the copolymer may be prepared as a dispersion by heating the solid copolymer with a water phase in a pressure reactor in the presence of a base, such as ammonia. In some embodiments, ammonia is included in amounts of about 0.1% to 2.0% by weight. Ammonia, in either its anhydrous or aqueous form, can be added to neutralize part or all of the acidic portion of the ethylene acrylic acid copolymer. The copolymer may be melted by heating the copolymer to a temperature from about 75° C. to about 190° C. at a pressure from about 300 psi to about 800 psi. The base reacts with the acid groups on the copolymer, and the copolymer forms a dispersion. According to other embodiments, instead of preparing an ethylene acrylic acid copolymer dispersion from scratch, a suitable commercially available copolymer dispersion may be employed. Suitable ethylene acrylic acid dispersions for use include, by way of example and not limitation, Primacor® 5985 and Primacor® 5990, commercially available from Dow Chemical Company.

In other embodiments, ethylene acrylic acid may be added to a reactor in a solid form and dispersed along with the polyamide. While various methods may be employed to form the dispersion, in various embodiments, melt-kneading is used. In some embodiments, a kneader, a Banbury mixer, a single-screw extruder, or a multi-screw extruder may be used. For example, a multi-screw extruder having two or more screws, to which a kneading block can be added at any position of the screws may be used.

In various embodiments, a twin screw extruder includes a base reservoir and an initial water reservoir, each of which includes a pump. Desired amounts of base and an initial amount of water are provided from the base reservoir and the water reservoir, respectively. In various embodiments, the base is ammonia. In some embodiments, the base and water are preheated.

Resin in the form of pellets is fed from a feeder to an inlet of the extruder, where the resin is melted or compounded. In some embodiments, the dispersing agent is added to the resin, while in other embodiments, the dispersing agent is provided separately to the twin screw extruder. In various embodiments, the “resin” is the polyamide and the “dispersing agent” is the ethylene acrylic acid copolymer described hereinabove. As an example, in various embodiments, pellets of ethylene acrylic acid copolymer and pellets of polyamide may be blended together before being fed into the extruder where they are melted and blended together.

The resin melt is then delivered to an emulsification zone of the extruder where the initial amount of water and base is added through an inlet. In some embodiments, the emulsified mixture is further diluted with additional water from the water reservoir in a dilution and cooling zone of the extruder.

In other embodiments, the polyamide, the ethylene acrylic acid copolymer dispersion, and optionally the polyurethane and/or additives, are combined by a high shear mixing process at ambient conditions. In some embodiments, however, the high shear mixing process may be performed partially or completely under elevated temperature and pressure.

The resulting heat seal coating is applied to substrates as an aqueous dispersion at ambient temperature in any suitable manner, including gravure coating, rod coating, wire rod coating, spray coating, screen printing, flexographic printing, or the like.

In various embodiments, the heat seal coating is applied to a substrate. Suitable substrates include cellulosic or polymeric, or metal-based substrates. Suitable cellulosic substrates include paper and other non-woven substrates. Suitable metallic or glass coated substrates include aluminum foil, metallized polymeric films, metallized paper, and AlOₓ or SiOₓ coated polymeric films. Suitable polymeric substrates include polyesters such as polyethylene terepthalate, polylactic acid (PLA), and polyhydroxyalkanoates (PHA), polyolefins such as biaxially oriented polyethylene terepthalate (BOP ET), polypropylene, biaxially oriented polypropylene (BOPP), cast polypropylene, polyethylene, and polyamides such as biaxially oriented polyamide and nylon, and polyvinyl chloride. Amorphous polyethylene polypropylene, polystyrene, and polycarbonate may also be suitable.

In some embodiments, the substrate may include single layer or multilayer structures. For example, a coated polyethylene terephthalate film may be adhered to a polypropylene or paper substrate. The coating may be applied to one or both sides of the substrate, depending on the particular embodiment.

The resulting coated substrate may be used for packaging food and other goods by applying heat and pressure to seal the substrate to itself or to another substrate. When a first substrate is heat sealed to a second substrate, one or both of the substrates may be coated with the heat seal coating. In other words, in some embodiments, the first substrate is coated with the heat seal coating while the second substrate is not, and in other embodiments, both the first and second substrates are coated with the heat seal coating. In embodiments employing two substrates, one or both of the substrates may be a cellulosic, polymeric, or metal-based substrate, as detailed hereinabove. The first and second substrates may be the same material, or the substrates may each be a different material from the other.

In some embodiments, such as embodiments in which the substrate is a polymeric substrate, before the coating is applied to the substrate, the surface of the substrate is treated to ensure that the coating will wet out the surface of the film. For example, the film may be treated using conventional techniques such as a flame or corona discharge treatment.

After the heat seal coating is applied, it may be dried to a clear, adherent film by hot air, radiant heat or any other suitable means. In various embodiments, the coating is applied to the substrate such that, when dried, it forms a coating having a thickness of from about 0.1 to about 4.0 microns. In some embodiments, the dried coating has a thickness of from about 0.5 to about 3.0 microns. In still other embodiments, the dried coating has a thickness of from about 1.0 micron to about 2.0 microns.

The heat seal coating may be used to form various flexible packaging structures including pouches, bags, sachets, and the like. The substrates may be sealed using conventional sealing equipment. An example of a commercially available heat sealer is LakoVool TS-12. The substrates may be sealed at a temperature above about 75° C. and at a pressure from about 20 psi to about 60 psi. In various embodiments, the sealing temperature is a temperature from about 75° C. to about 140° C.

When sealed, various embodiments described herein exhibit a seal strength of greater than 2 N/in. In some embodiments, the seal strength is from about 0.5 N/in to about 5.0 N/in. In other embodiments, the seal strength is from about 1.0 N/in to about 4.0 N/in.

It should be understood that various embodiments provide a single coating that includes both polyamide and ethylene acrylic acid. Conventionally, ethylene acrylic acid copolymers and polyamide were provided in separate layers to obtain the functional advantages of each of the components. For example, ethylene acrylic acid copolymer exhibits good adhesion to ink, but by itself lacks adhesion to some plastic substrates, such as biaxially oriented polyester (BOPET). While polyamide exhibits good adhesion to a wide range of plastic substrates, such as biaxially oriented polypropylene (BOPP) and BOPET, because of its instability in an aqueous dispersion, it is conventionally dispersed in solvent, especially organic solvents, which can lead to environmental problems when the solvent evaporates, or extruded as a film. However, the thickness of an extruded film (with or without additional coating layers, such as a coating including ethylene acrylic acid), may be limiting in various flexible packaging implementations. For example, a thinner coating can reduce the total thickness of the flexible packaging, may reduce costs associated with manufacturing and shipping, and may enable other coatings to be employed to provide other advantages, such as puncture-resistance, without exceeding a maximum total thickness.

In order that various embodiments may be more readily understood, reference is made to the following examples which are intended to illustrate the various embodiments, but not limit the scope thereof.

### Example 1

A heat seal coating was prepared by dispersing about 70% Macromelt 6239 polyamide by weight on a solids basis and about 30% ethylene acrylic acid by weight on a solids basis in water. The dispersion had about 30% by weight total solids. The heat seal coating was applied to corona-treated biaxially oriented polyethylene terephthalate (BOPET) at a dry coat weight of 3 gsm using a meyer rod such that the thickness of the coating was 3 microns. The coating was then heat sealed to itself at various temperatures at a seal pressure of 40 psi and a dwell time of 1 second. The heat sealing was performed using a commercially available heat sealer (LakoVool TS-12). Seal strength was tested using a Thwing Albert EJA Advantage tensile testing unit pursuant to ASTM F-88.

The results are shown below in Table 1.

TABLE 1
Heat Seal Strength at
Various Temperatures

| Temperature (° C.) | Seal Strength (g/in.) |
|---|---|
| 54 | 3.7 |
| 60 | 6.7 |
| 66 | 13.7 |
| 71 | 32.1 |
| 77 | Film failure |
| 82 | Film failure |
| 88 | Film failure |
| 93 | Film failure |
| 99 | Film failure |
| 104 | Film failure |

As can be seen, at higher temperatures, the films failed, i.e., the resulting bond strength of the sealed layers was stronger than the mechanical strength of the film.

### Example 2

A heat seal coating was prepared by dispersing about 70% Macromelt 6239 polyamide by weight on a solids basis and about 30% ethylene acrylic acid by weight on a solids basis in water. The dispersion had about 30% by weight total solids. The heat seal coating was applied to corona-treated biaxially oriented polyethylene terephthalate (BOPET), corona-treated biaxially oriented polypropylene (BOPP), and foil at a dry coat weight of 5 gsm and a thickness of 5 microns. The coating was then heat sealed to itself at various temperatures ranging from 77 to 110° C. at a seal pressure of 40 psi and a dwell time of 1 second. The heat sealing was performed using a commercially available heat sealer (LakoVool TS-12). Seal strength was tested using a Thwing Albert EJA Advantage tensile testing unit pursuant to ASTM F-88. Similar testing was conducted for other commercially available heat seal coatings based on polyurethane (PU), polyethylene acrylic acid copolymers (EAA) and polyethylene (PE) technologies. The maximum heat seal strength obtained for each coating within the specified heat seal temperature range is listed below in Table 2.

TABLE 2
Maximum Heat Seal Strength on BOPET, BOPP, and Foil

| | Maximum Seal | Maximum Seal | Maximum Seal |
|---|---|---|---|
| Heat Seal | Strength (N/in) | Strength (N/in) | Strength (N/in) |
| Coating Type | on BOPET | on BOPP | on Foil |
| Polyamide:EAA | 4.7 | 3.5 | 8.4 |
| EAA | 2.4 | 1.1 | 7.8 |
| EAA:PU | 0.8 | 5.0 | 3.6 |
| PE | 1.5 | 1.2 | 8.8 |

As can be seen, at higher temperatures, polyamide dispersion is the only heat seal coating that provides greater than the industry target of 2.0 N/in seal strength on all substrates.

### Example 3

A heat seal coating was prepared by dispersing about 63% Dispercoll U56 polyurethane by weight on a solids basis, 27% Macromelt 6239 polyamide by weight on a solids basis, and about 20% ethylene acrylic acid by weight on a solids basis in water. The dispersion included about 30% total solids by weight. The heat seal coating was applied to corona-treated biaxially oriented polyethylene terephthalate (BOPET) at a dry coat weight of 3 gsm using a meyer rod and a thickness of 3 microns. The coating was then heat sealed to itself at various temperatures at a seal pressure of 40 psi and a dwell time of 1 second. The heat sealing was performed using a commercially available heat sealer (LakoVool TS-12). Seal strength was tested using a Thwing Albert EJA Advantage tensile testing unit pursuant to ASTM F-88. The results are shown below in Table 3.

TABLE 3
Heat Seal Strength at
Various Temperatures

| Temperature (° C.) | Seal Strength (g/in.) |
|---|---|
| 54 | 98.2 |
| 60 | 111.4 |
| 66 | 121.2 |
| 71 | 295.7 |
| 77 | Film failure |
| 82 | Film failure |
| 88 | Film failure |
| 93 | Film failure |
| 99 | Film failure |
| 104 | Film failure |

As can be seen, at higher temperatures, the films failed, i.e., the resulting bond strength of the sealed layers was stronger than the mechanical strength of the film.

For the case of BOPET, the polyamide dispersion provides a significantly higher heat seal strength than any other coatings.

It will be apparent to those skilled in the art that modifications and variations can be made to the embodiments described herein without departing from the spirit and scope of the claimed subject matter. Thus it is intended that the specification cover the modifications and variations of the various embodiments described herein provided such modifications and variations come within the scope of the appended claims and their equivalents.

1. A coating for providing heat sealability to a substrate comprising:
an aqueous dispersion comprising a mixture of a polyamide and a copolymer of ethylene and acrylic acid;
wherein the aqueous dispersion is substantially free of non-aqueous plasticizers and organic solvents.

2. The coating of claim 1, wherein the coating further comprises one or more of a defoaming agent and a wetting agent.

4. The coating of claim 1 having a heat seal initiation temperature of between about 75° C. and about 140° C.

5. The coating of claim 4, wherein the coating comprises from about 30% to about 70% by weight polyamide and from about 10% to about 40% by weight ethylene acrylic acid copolymer based on solids in the aqueous dispersion.

6. The coating of claim 4, wherein the aqueous dispersion further comprises polyurethane.

7. The coating of claim 4, wherein the polyamide is an amine-terminated polyamide.

8. A heat sealable substrate comprising a substrate coated with a heat seal layer, wherein the heat seal layer comprises an aqueous dispersion including a mixture of polyamide and a copolymer of ethylene and acrylic acid, wherein the heat seal layer has a heat seal initiation temperature of between about 75° C. and about 140° C.

9. The heat sealable substrate of claim 8, wherein the heat seal layer has a thickness of from about 0.1 micron to about 4.0 microns.

10. The heat sealable substrate of claim 8, wherein the heat seal layer has a thickness of from about 0.5 micron to about 3.0 microns.

11. The heat sealable substrate of claim 8, wherein the heat seal layer has a thickness of from about 1.0 microns to about 2.0 microns.

12. The heat sealable substrate of claim 8, wherein the polyamide is an amine-terminated polyamide.

13. The heat sealable substrate of claim 8, wherein the substrate is selected from the group consisting of aluminum foil, a metallized polymeric film, a metallized paper, an AlOₓ or SiOₓ coated polymeric film, polyethylene terepthalate, polylactic acid (PLA), polyhydroxyalkanoate (PHA), biaxially oriented polyethylene terepthalate (BOP ET), polypropylene, biaxially oriented polypropylene (BOPP), polyethylene, biaxially oriented polyamide, nylon, amorphous polyethylene polypropylene, polystyrene, polycarbonate, and polyvinyl chloride.

14. A method of heat sealing substrates comprising:
applying an aqueous dispersion to a first substrate; the aqueous dispersion comprising from about 10% to about 50% by weight solids and the balance water and ammonia, wherein the solids comprise a mixture of polyamide and a copolymer of ethylene and acrylic acid;
drying the aqueous dispersion on the first substrate to form a coating on the first substrate; and
heat sealing the first substrate to a second substrate at a temperature ranging from about 75° C. to about 140° C.

15. The method of heat sealing substrates of claim 14, wherein the polyamide is an amine-terminated polyamide.

16. The method of heat sealing substrates of claim 14, wherein the first substrate comprises a first material and the second substrate comprises a second material that is different from the first material.

17. The method of heat sealing substrates of claim 14, further comprising:
applying the aqueous dispersion to the second substrate; and
drying the aqueous dispersion on the second substrate to form a coating on the second substrate.

18. The method of heat sealing substrates of claim 14 wherein the solids consist of:
about 30% to about 70% by weight polyamide based on solids in the aqueous dispersion;
about 0% to about 60% by weight polyurethane based on solids in the aqueous dispersion; and
from about 10% to about 40% by weight ethylene acrylic acid copolymer based on solids in the aqueous dispersion.

19. The method of heat sealing substrates of claim 14, further comprising:
treating the first substrate with a flame or corona discharge treatment prior to applying the aqueous dispersion.

20. The method of heat sealing substrates of claim 14, wherein at least one of the first substrate and the second substrate comprise aluminum foil, a metallized polymeric film, a metallized paper, an AlOₓ or SiOₓ coated polymeric film, polyethylene terepthalate, polylactic acid (PLA), polyhydroxyalkanoate (PHA), biaxially oriented polyethylene terepthalate (BOPET), polypropylene, biaxially oriented polypropylene (BOPP), polyethylene, biaxially oriented polyamide, nylon, amorphous polyethylene polypropylene, polystyrene, polycarbonate, or polyvinyl chloride.
